(19) United States
(12) Patent Application Publication
(10) Pub. No.: US 2025/0104169 A1
(43) Pub. Date: Mar. 27, 2025

(54) SYSTEM, APPARATUS AND METHOD FOR TRAVEL BOOKING SEARCH NORMALIZATION AND CONTROLLING A DISPLAY TO GENERATE RESULTS

(71) Applicant: Amadeus S.A.S., Biot (FR)

(72) Inventors: Cecile Jouve, Nice (FR); Celine Graire, Grasse (FR); Marine Lasserre, Antibes (FR); Thomas Ernest, Antibes (FR)

(21) Appl. No.: 18/372,251

(22) Filed: Sep. 25, 2023

(51) Int. Cl. G06Q 50/14; G06F 16/9538; G06Q 30/0601

(52) U.S. Cl. CPC G06Q 50/14; G06F 16/9538; G06Q 30/0625

(57) ABSTRACT

The present specification provides, amongst other things, a computing resource optimization engine that can normalize heterogenous travel itinerary data from different travel actor engines and generate a normalized itinerary on a display device.

### FIELD

The present specification relates generally to computer searching technologies and mores specifically to normalization of travel booking search results.

### BACKGROUND

Internet searches for flight and other travel options often necessitate repeated attempts to find the ideal choice due to several factors. Firstly, the dynamic nature of airfare pricing, which is influenced by ever-changing supply and demand, results in fluctuating prices that make it difficult to pinpoint the best option at any given moment. Additionally, the sheer volume of available airlines, routes, and fare classes can overwhelm with countless possibilities. Furthermore, the presence of various online travel agencies and meta-search engines that aggregate data from multiple sources can sometimes lead to discrepancies in the information displayed. Lastly, individual preferences, such as layover duration, time of departure, and desired amenities, add another layer of complexity to the search process, requiring users to continually refine and repeat their searches to find the most suitable flight option. The repeated searches waste network resources as well as computing resources on the search devices and the servers receiving the queries. The problem is exacerbated for corporate travel when these search parameters are also further confined by corporate policy.

### SUMMARY

An aspect of the present specification provides a method for controlling a graphical interface of a computing device to generate normalized travel booking search results.

An aspect of the specification provides a computing resource optimization engine including a processor and a memory for storing instructions executable on the processor; the processor configured to: receive a data format of administrator travel itinerary parameters; receive an electronic request for a proposed travel itinerary; query a plurality of travel actor servers for the travel itinerary based on the request; receive a plurality of heterogeneous travel itinerary response messages from the travel actor servers; the messages including heterogeneous offer attributes data fields from different travel actor servers; parse each response message into a plurality of attributes; determine a normalized set of travel itineraries by mapping the heterogenous offer attributes data fields into corresponding parameters defined by the data format; control a display device to generate the normalized set of travel itineraries according to the parameters.

An aspect of the specification provides a computing resource optimization engine wherein the messages include heterogeneous fare class data fields including non-refundable fare, refundable fare with fee and fully refundable fare from a first travel actor server and including non-refundable fare and refundable fare with fee from a second travel actor server, and wherein the refundable fare with fee and fully refundable fare are merged into a single flexible fare parameter.

An aspect of the specification provides a computing resource optimization engine wherein the processor is further configured to discard at least one attribute that falls outside the parameters.

An aspect of the specification provides a computing resource optimization engine wherein the display device is interactive and can receive a selection of one of the itineraries.

An aspect of the specification provides a computing resource optimization engine wherein the display device can receive a selection of one of the parameters within the one of the itineraries.

An aspect of the specification provides a computing resource optimization engine wherein at least a portion of the parameters can be revealed or hidden on the display device for each of the itineraries.

An aspect of the specification provides a computing resource optimization engine wherein fare class data fields are within the portion of the parameters.

An aspect of the specification provides a computing resource optimization engine wherein the travel actor servers include one or more of a global distribution server and a new distribution capability (NDC) protocol-based server.

An aspect of the specification provides a computing resource optimization engine wherein the query is effected via an application programming interface (API) executing on the processor or travel actor servers.

An aspect of the specification provides a computing resource optimization engine wherein the travel actor servers can include air travel actor servers and rail travel actor servers.

An aspect of the specification provides a computing resource optimization method including: receiving a data format of administrator travel itinerary parameters; receiving an electronic request for a proposed travel itinerary; querying a plurality of travel actor servers for the travel itinerary based on the request; receiving a plurality of heterogeneous travel itinerary response messages from the travel actor servers; the messages including heterogeneous offer attributes data fields from different travel actor servers; parsing each response message into a plurality of attributes; determining a normalized set of travel itineraries by mapping the heterogenous offer attributes data fields into corresponding parameters defined by the data format; controlling a display device to generate the normalized set of travel itineraries according to the parameters.

An aspect of the specification provides a method wherein the messages include heterogeneous fare class data fields including non-refundable fare, refundable fare with fee and fully refundable fare from a first travel actor server and including non-refundable fare and refundable fare with fee from a second travel actor server, and wherein the refundable fare with fee and fully refundable fare are merged into a single flexible fare parameter.

An aspect of the specification provides a method further including discarding at least one attribute that falls outside the parameters.

An aspect of the specification provides a method wherein the display device is interactive and can receive a selection of one of the itineraries.

An aspect of the specification provides a method wherein the display device can receive a selection of one of the parameters within the one of the itineraries.

An aspect of the specification provides a method wherein at least a portion of the parameters can be revealed or hidden on the display device for each of the itineraries.

An aspect of the specification provides a method wherein fare class data fields are within the portion of the parameters.

An aspect of the specification provides a method wherein the travel actor servers include one or more of a global distribution server and a new distribution capability (NDC) protocol-based server.

An aspect of the specification provides a method wherein the query is effected via an application programming interface (API) executing on a processor or at least one of the travel actor servers.

An aspect of the specification provides a method wherein the travel actor servers can include air travel actor servers and rail travel actor servers.

The heterogeneous fare class data fields can include economy class, premium economy class and business class from a first travel administrator server and include economy class, flexible economy class, and first class from a second travel administrator server, and wherein the premium economy class and the flexible economy class are merged into a single flexible economy class parameter and the business class and first class are merged into single business class parameter.

The present specification also contemplates methods and computer readable media according to the foregoing.

### BRIEF DESCRIPTION OF THE FIGURES

FIG. 1 is a schematic diagram of a system for travel search normalization.

FIG. 2 is a block diagram of example internal components of the booking engine of FIG. 1.

FIG. 3 shows a flowchart depicting a method for travel search normalization.

FIG. 4 shows example performance of block 328 in the method of FIG. 3.

FIG. 5 shows another example performance of block 328 in the method of FIG. 3.

FIG. 6 shows an example of heterogeneous air travel actor content that can be managed using the booking engine of FIG. 1.

FIG. 7 shows an example of heterogeneous rail travel actor content that can be managed using the booking engine of FIG. 1.

FIG. 8 shows an example of heterogeneous accommodation travel actor content that can be managed using the booking engine of FIG. 1.

FIG. 9 shows an example of heterogeneous accommodation car rental actor content that can be managed using the booking engine of FIG. 1.

### DETAILED DESCRIPTION

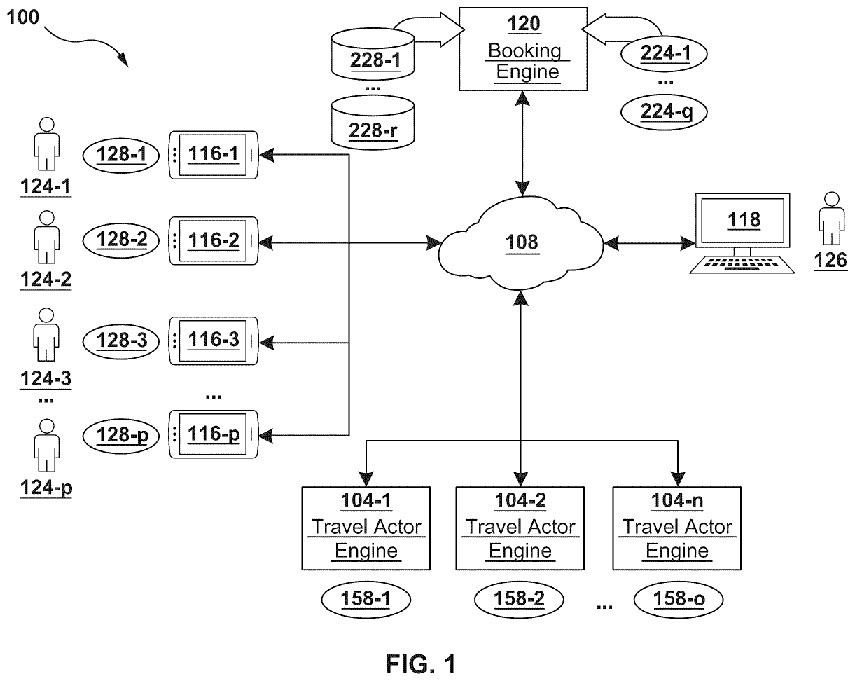

FIG. 1 shows a system for travel booking search normalization indicated generally at 100. System 100 comprises a plurality of travel actor engines 104-1, 104-2 . . . 104-n. (Collectively, engines 104-1, 104-2 . . . 104-n are referred to as engines 104, and generically, as engine 104. This nomenclature is used elsewhere herein.) In system 100, engines 104 connect to a network 108 such as the Internet. Network 108 interconnects travel actor engines 104 with a plurality of client devices 116, an administrator terminal 118 and a booking engine 120. As will be discussed further below, booking engine 120 performs a number of processing functions for system 100 which can optimize various computing resources in system 100.

Travel actor engines 104 can be based on any present or future electronic servers or computing architectures that, amongst other things, manage electronic schedules representing on behalf of carriers including their transportation routes, vehicles, fare classes, pricing, seating availability and any other aspects relevant to the operation of a scheduled transportation service available to the public.

Booking engine 120, can be any type of electronic server or computing architecture that facilitates searching and booking interactions between client devices 116 and travel actor engines 104.

Client devices 116 can be any type of human-machine interface for interacting with booking engine 120. For example, client devices 116 can include traditional laptop computers, desktop computers, mobile phones, tablet computers and any other device that can be used to receive and send content that complement the input and output hardware devices associated with a given client device 116. It is contemplated client devices 116 can include virtual or augmented reality gear complementary to virtual reality or augmented reality or “metaverse” environments that can be offered on collaboration engines 104. Client devices 116 can be operated by different users 124 that are associated with a respective identifier object 128 that uniquely identifies a given user 124 accessing a given client device 116 in system 100.

Administrator terminal 118 can also be any type of human-machine interface of the same types as client devices 116. Administrator terminal 118 is operated by an administrator 126.

The present specification contemplates scenarios where users 124 may travel from certain origins to certain destinations using different modes of travel such as air, rail, bus, ferries, car-pools or the like. Users 124 may thus interact with their devices 116 in order to conduct searches via system 100 to find itineraries offered by different travel actors such as airlines, railway companies, bus companies or other transportation carriers. Users 124 may also ultimately use system 100 to book those itineraries, although presently less-preferred embodiments of this specification also contemplate only a pure searching function. Administrator 126 operates administrator terminal 118 and receives input to define corporate travel policies at booking engine 120 for what types of travel services can be booked by users 124. (In this embodiment, which is optional, users 124 are employees or affiliates of a corporate entity that defines travel policies for those users 124).

In a present example embodiment, engines 104 can be based on servers hosted by individual transportation carriers such as airlines, railway companies, bus companies. As will become more apparent with the benefit of reading this specification, each engine 104 can integrated with other nodes in system 100 using their own application travel interfaces (API) s, or via travel aggregators like a global distribution system (GDS), such as Travelfusion, or Amadeus, or via aggregators such as Amadeus Travel, Rail or Hotel Platform), using certain APIs that can be based on the Electronic Data Interchange For Administration, Commerce and Transport, (“Edifact”) format or NDC protocol or another format.

Thus individual transportation carriers may, for example, rely on the New Distribution Capability (NDC) protocol. Alternatively, or in addition, one or more engines 104 can be based on a Global Distribution System (GDS) such as Amadeus, Sabre, or Travelport, which aggregate data including travel routes and pricing on behalf of individual travel actors. Engines 104 can thus be a combination of servers of individual travel actors using the NDC protocol and GDS aggregators acting on behalf of travel actors.

Accordingly, client devices 116 are based on any suitable client computing platform operated by users 124 that may have an interest in the travel itinerary content being provided by engines 104. Each device 116 and its user 124 is thus typically associated with a user identifier object 128, particularly if any booking functions are to be utilized. Administrator 126 can interact with system 100 via terminal 118 to define travel policies associated with each user identifier object 128.

A person of skill in the art is to recognize that the form of an identifier object 128 is not particularly limited, and in a simple example embodiment, can be simply an alpha-numerical sequence that is entirely unique in relation to other identifier objects in system 100. Identifier objects can also be more complex as they may be combinations of account credentials (e.g. user name, password, Two-factor authentication token, etc.) that uniquely identify a given user 124. Identifier objects themselves may also be indexes that point to other identifier objects, such as one or more accounts. The salient point is that they are uniquely identifiable within system 100 in association with what they represent.

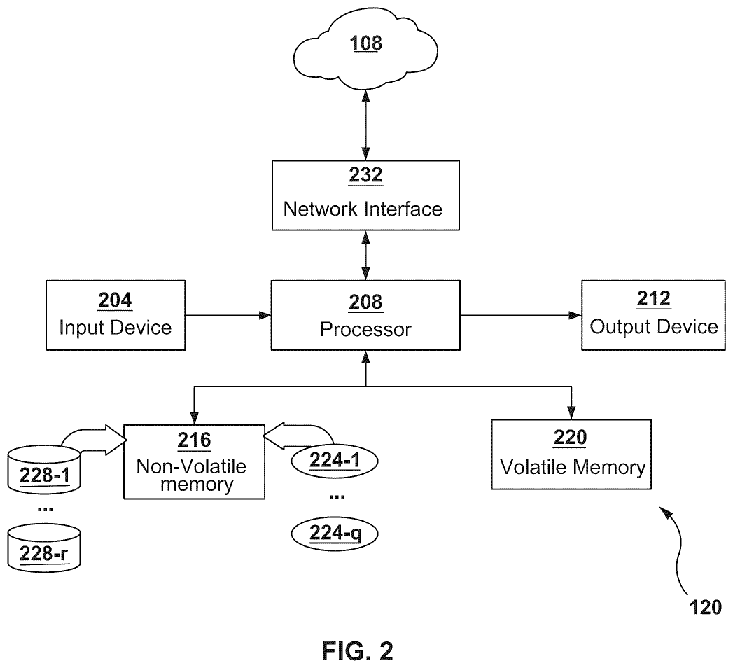

Having described an overview of system 100, it is useful to comment on the hardware infrastructure of system 100. FIG. 2 shows a schematic diagram of a non-limiting example of internal components of booking engine 120.

In this example, booking engine 120 includes at least one input device 204. Input from device 204 is received at a processor 208 which in turn controls an output device 212. Input device 204 can be a traditional keyboard and/or mouse to provide physical input. Likewise output device 212 can be a display. In variants, additional and/or other input devices 204 or output devices 212 are contemplated or may be omitted altogether as the context requires.

Processor 208 may be implemented as a plurality of processors or one or more multi-core processors. The processor 208 may be configured to execute different programing instructions responsive to the input received via the one or more input devices 204 and to control one or more output devices 212 to generate output on those devices.

To fulfill its programming functions, the processor 208 is configured to communicate with one or more memory units, including non-volatile memory 216 and volatile memory 220. Non-volatile memory 216 can be based on any persistent memory technology, such as an Erasable Electronic Programmable Read Only Memory (“EEPROM”), flash memory, solid-state hard disk (SSD), other type of hard-disk, or combinations of them. Non-volatile memory 216 may also be described as a non-transitory computer readable media. Also, more than one type of non-volatile memory 216 may be provided.

Volatile memory 220 is based on any random access memory (RAM) technology. For example, volatile memory 220 can be based on a Double Data Rate (DDR) Synchronous Dynamic Random-Access Memory (SDRAM). Other types of volatile memory 220 are contemplated.

Processor 208 also connects to network 108 via a network interface 232. Network interface 232 can also be used to connect another computing device that has an input and output device, thereby obviating the need for input device 204 and/or output device 212 altogether.

Programming instructions in the form of applications 224 are typically maintained, persistently, in non-volatile memory 216 and used by the processor 208 which reads from and writes to volatile memory 220 during the execution of applications 224. Various methods discussed herein can be coded as one or more applications 224. One or more tables or databases 228 are maintained in non-volatile memory 216 for use by applications 224.

The infrastructure of booking engine 120, or a variant thereon, can be used to implement any of the computing nodes in system 100, including travel actor engines 104. Furthermore, booking engine 120 and travel actor engines 104 may also be implemented as virtual machines and/or with mirror images to provide load balancing. Functions of booking engine 120 may also be distributed amongst different travel actor engines 104 and/or platforms 114, thereby obviating the need for a central booking engine 120. By the same token, a plurality of booking engines 120 may be provided.

Furthermore, a person of skill in the art will recognize that the core elements of processor 208, input device 204, output device 212, non-volatile memory 216, volatile memory 220 and network interface 232, as described in relation to the server environment of booking engine 120, have analogues in the different form factors of client machines such as those that can be used to implement client devices 116 and administrator terminal 118. Again, client devices 116 can be based on computer workstations, laptop computers, tablet computers, mobile telephony devices or the like.

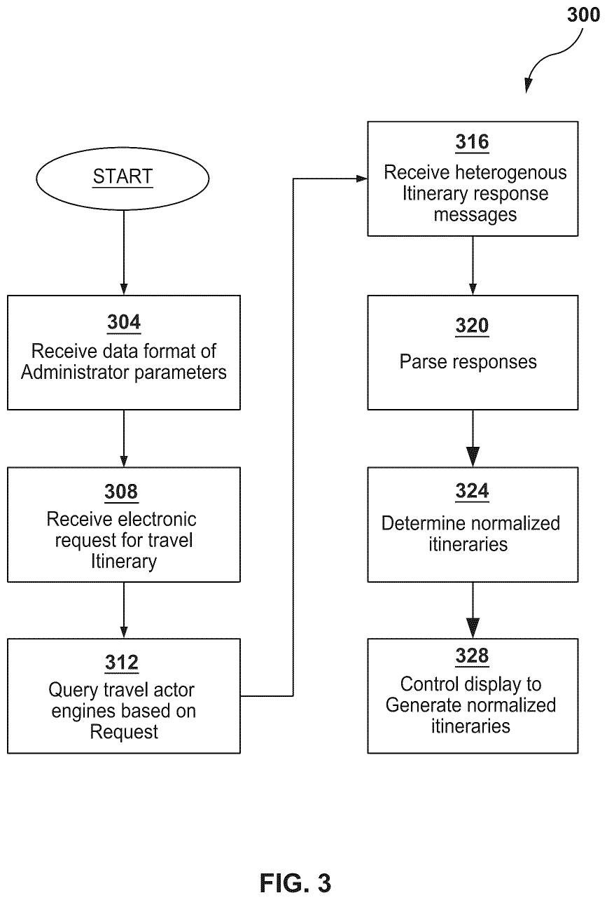

FIG. 3 shows a flowchart depicting a method for travel booking search normalization indicated generally at 300. Method 300 can be implemented on system 100. Persons skilled in the art may choose to implement method 300 on system 100 or variants thereon, or with certain blocks omitted, performed in parallel or in a different order than shown. Method 300 can thus also be varied. However, for purposes of explanation, method 300 will be described in relation to its performance on system 100 with a specific focus on treating method 300 as, for example, application 224-1 maintained within booking engine 120 and its interactions with the other nodes in system 100.

Block 304 comprises receiving a data format of administrator parameters. Two concepts are addressed in block 304. First, a data format, which, as will be discussed further below affects how search results are generated, and second, administrator parameters which represent the travel policies for each user. In system 100, booking engine 120 receives the data format from administrator terminal 118 and administrator 126. In a simple illustrative example, administrator 120 can identify a plurality of tiers, with one tier can assigned to each user 124. Table 228-1 shows an example.

TABLE 228-1
Example Data Format of Administrator Parameters

| Identifier object | Tier | Tier Parameters |
|---|---|---|
| Identifier object 128-1 | Tier 1 | Cheapest fare, 1 Checked-in bag |
| (User 124-1) | | included |
| Identifier object 128-2 | Tier 2 | Semi-Flexible Fare, Economy |
| (User 124-2) | | Class seat |
| Identifier object 128-3 | Tier 3 | Flexible Fare, Economy Class |
| (User 124-3) | | Seat |
| Identifier object 128-p | Tier 4 | Flexible Fare, Business Class |
| (User 124-p) | | Seat |

Explaining Table 228-1 in greater detail, the Tier Parameters indicate what restrictions or permissions are granted to each user 124 when booking travel on booking engine 120. (Table 228-1 is focused on flights as a non-limiting example, but other travel actors are contemplated such as accommodation, meals, etc.). The Tier Parameters can be provided in a structured data form, or a large language model (LLM) can be used to allow administrator 126 to enter information in unstructured form and the LLM can make it structured. For example, the Tier Parameters in Table 228-1 can be parsed into “Parameters” and “Sub-Parameters”. “Semi-Flexible Fare” and “Flexible Fare” from Table 228-1 can be generalized into the Parameter “Fare Class”, while each particular type of fare can be mapped into a corresponding sub-parameter. “Economy Class seat” and “Business Class set” can be generalized into the Parameter “Seat Class”, while each type of seat can be mapped into a corresponding sub-parameter. “Cheapest Fare” can be mapped into the Parameter/Sub-parameter “Non-refundable” “Checked-in bag” can be generalized into the Parameter “Baggage Allowance”, while the specific permission to have a checked in bag can be mapped to a corresponding sub-parameter.

Table 228-2 shows how the foregoing Tier Parameters and sub-parameters can be defined in order to establish structured search criteria for engine 120. The specific examples from Table 228-1 can be found in Table 228-2, but it will be apparent that Table 228-2 contains a large number of parameters and sub-parameters that can be applied to Table 228-1.

TABLE 228-2
Example Definitions for Tier Parameters

| | Sub- | |
|---|---|---|
| Parameter | Parameter | Definition/Description |
| Fare class | | Fare class, also known as booking class or fare code, |
| | | refers to the different categories of tickets available for |
| | | purchase based on price, restrictions, and availability. |
| | | Each fare class is represented by a letter code and has |
| | | different rules associated with it, such as refundability, |
| | | change fees, and eligibility for upgrades. Fare classes |
| | | also determine how many frequent flyer miles or points a |
| | | passenger can earn for a particular flight. Airlines often |
| | | have multiple fare classes within the same cabin or seat |
| | | class, with varying prices and conditions. |
| | Non- | A non-refundable fare class refers to a category of airline |
| | refundable | tickets that cannot be refunded if the passenger decides |
| | | to cancel or change their travel plans. These fares are |
| | | typically cheaper than refundable fares, as they offer less |
| | | flexibility in terms of cancellations and modifications. |
| | Semi-flexible | These fares have some restrictions, but they still allow for |
| | Fares | changes or cancellations with reduced fees compared to |
| | | non-refundable fares. |
| | Flexible | A flexible fare class refers to a category of airline tickets |
| | | that allow passengers to make changes or cancellations |
| | | to their travel plans with fewer restrictions compared to |
| | | non-refundable fares. Flexible fares, also known as |
| | | refundable fares, generally come with a higher price due |
| | | to the added flexibility and benefits they provide. |
| Seat class | | Seat class, also known as cabin class or travel class, |
| | | refers to the different sections of an airplane with varying |
| | | levels of service, comfort, and amenities. Common seat |
| | | classes include |
| | Economy | This is the most basic and affordable class, offering |
| | class (also | standard seating with limited legroom and basic in-flight |
| | known as | services. |
| | coach class) | |
| | Premium | A step above economy class, premium economy offers |
| | economy | more legroom, wider seats, and enhanced amenities |
| | class | compared to standard economy. |
| | Business | This class provides passengers with more comfortable |
| | class | seating (often lie-flat seats), better in-flight services, and |
| | | access to airport lounges. Business class is usually more |
| | | expensive than economy or premium economy but less |
| | | expensive than first class. |
| | First class | The most luxurious and expensive class, first class offers |
| | | passengers the highest level of service, comfort, and |
| | | privacy. Amenities may include private suites, gourmet |
| | | meals, and access to exclusive airport lounges. |
| Baggage | | The number of checked and carry-on bags allowed per |
| Allowance | | passenger, as well as the weight and size limitations, can |
| | | affect ticket prices. Some airlines include a certain |
| | | baggage allowance in the ticket price, while others |
| | | charge extra fees for checked baggage or even carry-on |
| | | bags. |
| | Carry-on | Some airlines, particularly low-cost carriers, may only |
| | baggage only | allow passengers to bring one carry-on bag and one |
| | | personal item (such as a purse, laptop bag, or small |
| | | backpack) without any additional fees. There may be |
| | | weight and size restrictions for these items. |
| | Checked | Some airlines may include one or more checked bags in |
| | baggage | the ticket price, particularly for international flights or |
| | included | higher fare classes. For example, an airline might allow |
| | | passengers to check one bag weighing up to 50 pounds |
| | | (23 kg) for free. |
| In-flight | | The inclusion or exclusion of meals and beverages can |
| meals and | | impact the ticket price. Some airlines offer complimentary |
| beverages | | meals and drinks for all passengers, while others provide |
| | | these services only in premium cabins or charge extra |
| | | fees for meals in economy class. |
| | Purchase | For flights where food is offered for purchase, but no |
| | Only | meals are included with the ticket purchase. |
| | Standard | Typically includes a main course, side dish, bread, and |
| | meal | dessert, along with non-alcoholic beverages. |
| | Vegetarian | Includes a variety of vegetarian options, such as pasta, |
| | meal | rice, or vegetable-based dishes, along with non- |
| | | alcoholic beverages. |
| | Vegan meal | Excludes all animal products, such as meat, dairy, and |
| | | eggs, and may include dishes such as lentil soup, |
| | | vegetable stir-fry, or fruit salad, along with non-alcoholic |
| | | beverages. |
| | Gluten-free | Caters to passengers with gluten intolerance or celiac |
| | meal | disease and may include options such as gluten-free |
| | | pasta, rice, or bread, along with non-alcoholic |
| | | beverages. |
| | Kosher meal | Follows the dietary laws of Judaism and may include |
| | | meat, fish, or vegetarian options, along with non- |
| | | alcoholic beverages. |
| | Halal meal | Complies with Islamic dietary laws and may include |
| | | meat, fish, or vegetarian options, along with non- |
| | | alcoholic beverages. |
| | Child meal | Suitable for children under 12 years old and may include |
| | | kid-friendly options, such as chicken nuggets, mac and |
| | | cheese, or fruit cups, along with juice or other non- |
| | | alcoholic beverages. |
| Seat | | Some airlines charge extra fees for seat selection, |
| selection | | especially for preferred seats with extra legroom or seats |
| within | | located near the front of the cabin. Other airlines may |
| Economy | | include seat selection as part of the ticket price. |
| Class | | |
| | Standard | These are the regular economy class seats with basic |
| | seats | legroom and seat width. Passengers can select these |
| | | seats at no additional cost or for a small fee, depending |
| | | on the airline's policy. |
| | Preferred | These seats are typically located in the front section of |
| | seats | the economy cabin, offering easier boarding and |
| | | deplaning. Some airlines may charge a premium for |
| | | these seats. |
| | Extra legroom | Also known as Economy Plus or Main Cabin Extra, |
| | seats | these seats offer additional legroom compared to |
| | | standard economy seats. These seats are usually |
| | | priced higher than standard seats and can be |
| | | particularly attractive for taller passengers or those |
| | | seeking extra comfort. |
| | Exit row seats | These seats are located next to the emergency exit |
| | | doors and offer significantly more legroom than regular |
| | | seats. Airlines may charge a premium for exit row seats, |
| | | and passengers must meet certain safety requirements |
| | | to be eligible for these seats. |
| | Bulkhead | Located directly behind a cabin divider or the galley, |
| | seats | these seats offer extra legroom as there is no seat |
| | | directly in front. Some passengers may prefer these |
| | | seats for the extra space, but others may find them less |
| | | desirable due to the proximity to the lavatories or lack of |
| | | under-seat storage. |
| | Seats with | These seats are located near the cabin divider and have |
| | bassinet | provisions for attaching a bassinet for passengers |
| | positions | traveling with infants. These seats may be assigned |
| | | upon request or automatically assigned to passengers |
| | | with infants. |
| In-flight | | The availability and quality of in-flight entertainment, |
| entertainment | | such as movies, music, and games, can affect ticket |
| | | prices. Some airlines offer free in-flight entertainment, |
| | | while others charge for access or provide it only in |
| | | premium cabins. |
| | Personal | Many airlines offer individual screens for passengers, |
| | seatback | allowing them to watch movies, TV shows, or other |
| | screens | video content, listen to music, and play games. |
| | Inflight Wi-Fi | Some airlines provide Wi-Fi connectivity for passengers |
| | | to access the internet, stream content, or use |
| | | messaging apps during the flight. This service may be |
| | | available for free or for a fee. |
| | Mobile device | Airlines may offer an app or website that passengers |
| | streaming | can access on their personal devices, such as |
| | | smartphones or tablets, to stream movies, TV shows, |
| | | and music during the flight. |
| | Live TV | Select airlines offer live satellite TV, allowing |
| | | passengers to watch news, sports, or other live |
| | | broadcasts during the flight. |
| | Inflight | Airlines often provide a complimentary inflight |
| | magazine | magazine, which includes articles about travel, |
| | | destinations, culture, and lifestyle. |
| Wi-Fi access | | Wi-Fi access Some airlines charge extra fees for in-flight |
| | | Wi-Fi access, while others include it in the ticket price or |
| | | offer it for free. |
| | Basic Wi-Fi | Suitable for messaging and browsing, offers limited |
| | | speed and data allowance, ideal for light internet usage. |
| | Standard Wi- | Provides moderate speed and data allowance, allowing |
| | Fi | for email, social media, and basic streaming. |
| | Premium Wi- | Offers high speed and increased data allowance, |
| | Fi | suitable for video streaming, video calls, and large file |
| | | downloads. |
| | Hourly Wi-Fi | Allows passengers to purchase Wi-Fi access for a |
| | pass | specific duration, typically one hour, at a fixed rate. |
| | Flight pass | Provides unlimited Wi-Fi access for the entire duration |
| | | of the flight, available at a fixed price. |
| | Pay-as-you- | Charges passengers based on actual data usage, with |
| | go | rates determined by the amount of data consumed. |
| Priority | | Access to priority check-in, boarding, and baggage |
| services | | handling can also influence ticket prices. These services |
| | | may be included in premium cabin tickets or available as |
| | | add-on options for an additional fee. |
| | Priority | Allows passengers to board the aircraft before other |
| | boarding | passengers, providing more time to settle into their |
| | | seats and stow their carry-on luggage. |
| | Priority | Gives passengers access to a separate check-in |
| | check-in | counter or a priority lane, which typically has shorter |
| | | wait times than the regular check-in lines. |
| | Priority | Ensures that the passenger's checked baggage is |
| | baggage | among the first to be unloaded from the aircraft upon |
| | handling | arrival, reducing the wait time at the baggage claim. |
| | Lounge | Provides access to the airline's lounge, which offers |
| | access | comfortable seating, complimentary food and |
| | | beverages, and other amenities such as Wi-Fi and |
| | | shower facilities. |
| | Fast track | Allows passengers to bypass the regular security queue |
| | security | and use a dedicated, expedited security line. |
| | Chauffeur | Includes a personal driver who meets the passenger at |
| | service | the airport and takes them to their destination in a |
| | | private vehicle. |
| | Onboard | Contains a variety of travel essentials, such as eye |
| | amenities kit | masks, earplugs, toothbrush and toothpaste, socks, and |
| | | lotion. |
| Loyalty | | Airlines may offer discounted ticket prices or special |
| programs and | | promotions to members of their loyalty programs or |
| partnerships | | through partnerships with other airlines, credit card |
| | | companies, or travel agencies. |
| | Frequent flyer | Allow passengers to earn points or miles for every flight |
| | programs | they take with a particular airline, which can be |
| | | redeemed for future flights, upgrades, or other rewards. |
| | | The number of points earned typically depends on the |
| | | distance flown, seat class, and fare class. |
| | Seat class | Some airlines offer bonus points for flying in premium |
| | multipliers | seat classes, such as business or first class, which can |
| | | significantly increase the number of points earned for |
| | | the flight. |
| | Fare class | Some airlines offer bonus points for purchasing higher |
| | multipliers | fare classes, such as flexible or premium fares, which |
| | | can significantly increase the number of points earned |
| | | for the flight. |
| | Partner | Many airlines have partnerships with other airlines, |
| | airlines | allowing passengers to earn points or miles on their |
| | | loyalty program for flights with partner airlines. |
| | Hotel and car | In addition to flights, many airlines have partnerships |
| | rental | with hotel chains and car rental companies, allowing |
| | partners | passengers to earn points or miles for hotel stays and |
| | | car rentals. |
| | Retail and | Some airlines have partnerships with retail stores, |
| | other partners | restaurants, and other businesses, allowing passengers |
| | | to earn points or miles for purchases made at these |
| | | partners. |

A person of skill in the art will now appreciate that the parameters in Table 228-2 are merely examples and that different, additional and/or fewer parameters may be included. Such parameters are derived from the offerings of various airlines via different travel actor engines 104. It is also to be understood that Table 228-2 may be extended to other hospitality examples, including accommodations, meals and events. However, the following discussion will focus on the contents of Table 228-2 as shown for illustrative purposes.

It will also now be appreciated that the contents of Table 228-2 can be used to create a rich set of Tiers for each user 124 within Table 228-1, selecting from a variety of different parameters and sub-parameters. A rich user interface can also be generated on administrator terminal 118 to allow administrator 126 to establish the contents of Table 228-1 in a user-friendly manner. However, the following discussion will focus on the contents of Table 228-1 as shown for illustrative purposes.

Block 308 comprises receiving an electronic request for a proposed travel itinerary. In system 100, booking engine 120 receives a request from one of the client devices 116 on behalf of a user 124 as identified via their respective identifier object 128. To continue the illustrative example, it will be assumed that booking engine 120 receives an electronic signal from device 116-1 on behalf of user 124-1 for a flight from Sophia Airport (Code “SOF”) in Sophia, Bulgaria to Orly Airport (“ORY”) in Paris, France. (The search may include a specific date or range of dates or may specify a return flight. These and other variables are not necessary to explain this example).

Block 312 comprises querying relevant e-commerce vendor platforms based on the data signal received at block 308. In a present example, block 312 comprises querying the travel actor engines 104 (i.e. vendor platforms) that maintain datasets that include travel actor options that are based on the itinerary from block 308. The query can be sent broadly, across a plurality of the travel actor engines 104, and the query response can include a plurality of responses from different travel actors whose data is maintained on those travel actor engines 104. The responses typically each include an identifier of the travel actor, as well as various attributes including the price and duration of the transportation. The responses and their attributes typically include specific content corresponding to the parameters and sub-parameters in Table 228-2. While information such as price and duration can be considered “metadata”, the responses also include additional parameters such as fare classes, seat classes, baggage allowances, as found in Table 228-2 and can also include aircraft, number of stops, layover times, carbon emissions, airport identifiers, terminal information, and the like. The type of additional information is not particularly limited, but in general provides greater detail than the metadata.

Block 316 comprises receiving heterogeneous itinerary response messages. The itinerary response messages can include attribute data fields that store offers, but those data fields are themselves non-normalized, and as such are heterogenous. The heterogeneousness derives from the fact that different travel actor engines 104 and their associated airlines (or other travel actors) may choose to sell seats and offer services in a different manner than others. The differences may include substantive information such as flight times and aircraft. The differences may also include variations between different travel actors in seat classes and fare classes within those seat classes. For example, a low cost carrier (LCC) may not even offer anything other than economy class and the option to pay for luggage, while a full-service airline may offer multiple seat classes and, depending on include fare classes that include baggage and other fare classes that exclude baggage.

The results received at block 316 can be stored in a table. Table 228-3 shows an example of the results that can be received at block 316 and stored in Table 228-3.

TABLE 228-3
Example Raw Itinerary Response

| | | Departure | Arrival | | Seat | Baggage | Price | |
|---|---|---|---|---|---|---|---|---|
| Airline | Flight | Time | Time | Fare Class | Class | Allowance | (USD) | Etc. |
| Airline | AA123 | 10:00 | 12:00 | Non- | Economy | 1 checked | $150 | . . . |
| A | | | | Refundable | | bag, 1 | | |
| | | | | | | carry-on | | |
| Airline | AA123 | 10:00 | 12:00 | Semi- | Economy | 1 checked | $200 | . . . |
| A | | | | Flexible | | bag, 1 | | |
| | | | | | | carry-on | | |
| Airline | AA123 | 10:00 | 12:00 | Flexible | Business | 2 checked | $500 | . . . |
| A | | | | | | bags, 2 | | |
| | | | | | | carry-ons | | |
| Airline | BB456 | 14:00 | 16:00 | Non- | Economy | No | $100 | . . . |
| B | | | | Refundable | | checked | | |
| | | | | | | bag, 1 | | |
| | | | | | | carry-on | | |
| Airline | BB456 | 14:00 | 16:00 | Semi- | Premium | 1 checked | $250 | . . . |
| B | | | | Flexible | Economy | bag, 1 | | |
| | | | | | | carry-on | | |
| Airline | BB456 | 14:00 | 16:00 | Flexible | Business | 2 checked | $400 | . . . |
| B | | | | | | bags, 2 | | |
| | | | | | | carry-ons | | |
| Airline | CC789 | 18:00 | 20:00 | Non- | Economy | 1 checked | $180 | . . . |
| C | | | | Refundable | | bag, 1 | | |
| | | | | | | carry-on | | |
| Airline | CC789 | 18:00 | 20:00 | Semi- | Economy | 1 checked | $220 | . . . |
| C | | | | Flexible | | bag, 1 | | |
| | | | | | | carry-on | | |
| Airline | CC789 | 18:00 | 20:00 | Flexible | Business | 2 checked | $450 | . . . |
| C | | | | | | bags, 2 | | |
| | | | | | | carry-ons | | |

(The highlighting in Table 228-3 is discussed further below.)

Table 228-3 thus includes a plurality of itinerary options that include the parameters from Table 228-1. The “Etc.” column in Table 228-3 is to denote that other parameters can be returned, but the columns shown in Table 228-3 are germane to our illustrative example. Those other parameters may be used when Table 228-1 includes different parameters for different Tiers.

Block 320 comprises parsing the responses from block 316. Table 228-3 at this point is raw data, and so the relevant parameters for Table 228-1 and Table 228-2 need to be located and extracted. Columns “Airline”; “Flight”; “Departure Time”, and “Arrival Time” form the foundational information for the itineraries. Columns “Fare Class”; “Seat Class”; “Baggage Allowance”; and “Price (USD)” are germane to the parameters from Table 228-1. Accordingly, the contents of each corresponding cell are parsed for extraction and further processing.

Block 324 comprises determining normalized itineraries. The normalized itineraries are based on the parameters from block 304 (i.e. Table 228-1) as applied to the responses parsed at block 320 (i.e. Table 228-3). Table 228-4 continues our example by showing the itineraries from each airline that satisfy the parameters “Cheapest fare, 1 Checked-in bag included” according to Tier 1 associated with user 224-1. (For convenience, the equivalent rows are highlighted in Table 228-3.

TABLE 228-4
Example Raw Itinerary Response

| | | Departure | Arrival | | Seat | Baggage | Price |
|---|---|---|---|---|---|---|---|
| Airline | Flight | Time | Time | Fare Class | Class | Allowance | (USD) |
| Airline | AA123 | 10:00 | 12:00 | Non- | Economy | 1 checked | $150 |
| A | | | | Refundable | | bag, 1 | |
| | | | | | | carry-on | |
| Airline | BB456 | 14:00 | 16:00 | Semi- | Premium | 1 checked | $250 |
| B | | | | Flexible | Economy | bag, 1 | |
| | | | | | | carry-on | |
| Airline | CC789 | 18:00 | 20:00 | Non- | Economy | 1 checked | $180 |
| C | | | | Refundable | | bag, 1 | |
| | | | | | | carry-on | |

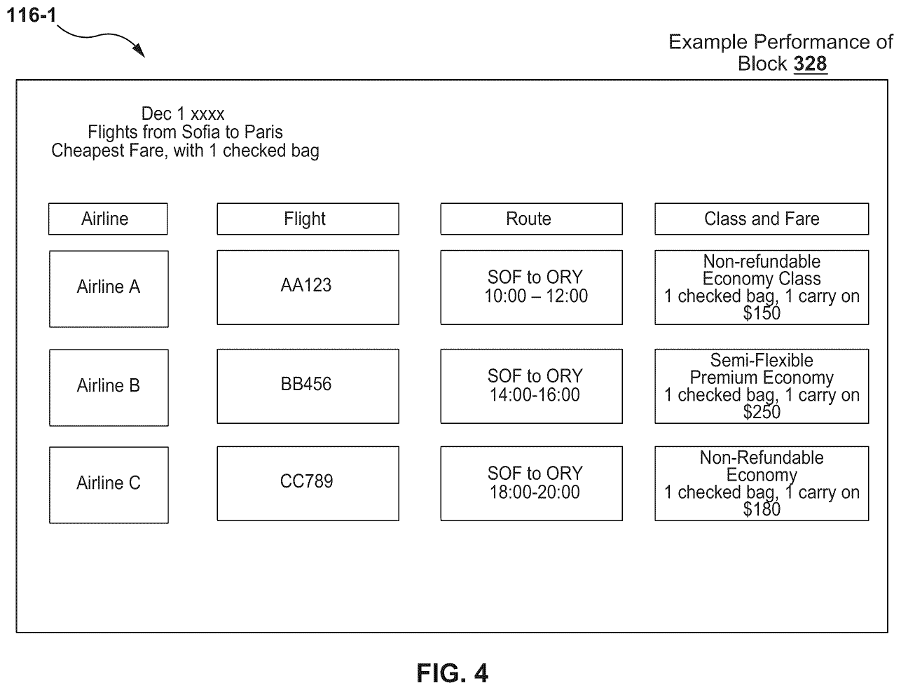

Block 328 comprises controlling a display to generate the normalized itineraries. Performance of block 328 is shown in FIG. 4 according to our example, where the results of Table 228-4 are shown in a grid format on the display of device 116-1. In certain embodiments, user 224-1 can interact with device 116-1 to select and one of the flights to proceed with booking the flight. A person of skill in the art will now appreciate the technical advantage of showing Table 228-4 rather than the entirety of Table 228-3. Only the highlighted rows in Table 228-3 comply with corporate travel policy, and thus not only would Table 228-4 clutter the display and may require multiple screen-pages to be shown, indeed there are only three options, in any event, that can be validly chosen. Thus showing only Table 228-3 saves computational, memory, bandwidth and screen display resources within system 100, and specifically on device 116-1 itself.

A person of skill in the art will now appreciate that the simple example from Table 228-1 can be scaled into much more complex scenarios and by normalizing the different types of results from different travel actor engines 104, an additional filter of a set of parameters can be applied to further curate the results into a reduced set of results that reflect meaningful options for the user. For example, a variant on Table 228-1 is shown below, labelled 228-1a

TABLE 228-1a
Second Example Data Format of Administrator Parameters

| | | Tier Parameters | |
|---|---|---|---|
| | Tier Parameters | For flights between | Tier Parameters |
| Identifier | For flights under | four and eight | For flights between |
| object | Four hours | hours | over eight |
| Identifier object | Cheapest fare, 1 | Semi-flexible fare, | Semi-Flexible Fare, |
| 128-1 (User | Checked-in bag | Economy Class | Business Class Seat, |
| 124-1) | included | Seat | Pay as you go wifi. |
| Identifier object | Semi-Flexible | Flexible Fare, | Flexible Fare, |
| 128-2 (User | Fare, Economy | Economy Class | Business Class Seat, |
| 124-2) | Class seat | seat, Exit Row | Flight Pass Wifi |
| | | Seats | |
| Identifier object | Flexible Fare, | Flexible Fare, | Cheapest Business |
| 128-3 (User | Economy Class | Economy Class | Class Seat, |
| 124-3) | Seat | Seat, Premium | regardless of Fare |
| | | Seat, Personal | Class |
| | | Seat Back | |
| | | Entertainment | |
| | | Screen | |
| Identifier object | Flexible Fare, | Flexible Fare, | Flexible Fare, First |
| 128-p (User | Economy Class | Business Class | Class Seat, Wifi |
| 124-p) | Seat, Preferred | Seat | included, Chauffeur |
| | Seating | | Service, Loyalty |
| | | | Program Fare Class |
| | | | Multiplier |

Table 228-1a thus identifies three different sets of tier parameters for each user 124, that depends on flight duration. Each set of tier parameters is uniquely tailored for the user 124 according to flight duration. When method 300 is performed with Table 228-1a in combination with Table 228-2, a much more complex set of results can be generated than the example Table 228-3, depending on the resulting flight duration from whatever search is requested at block 308. During this performance block 324, the flight durations are extracted then Table 228-1a is applied in combination with Table 228-2, against the search results generated at block 316. The relevant user 124 can then be presented with a heavily filtered set of results, with only the most relevant search results that comply with corporate policies of Table 228-1a being generated at block 328.

In view of the above it will now be apparent that variants, combinations, and subsets of the foregoing embodiments are contemplated. For example, the teachings herein can be expanded to other types of travel actors such as restaurants, spas, concert venues, exhibition centers, summits, sporting event venues, fairs, conference venues, sporting arenas, museums, art galleries, tours and resort activity centers and the like. The teachings herein may be expanded to cover vacation packages that include combinations of transportation, accommodation, meals and/or destination activities. In the case of hotels, for example, parameters for room sizes, bed options, included meal plans and cancellation options can be readily defined in a variant of Table 228-1 and Table 228-2. Similar variations to Table 228-1 and Table 228-2 can be applied to other types of travel actors.

As another example, block 328 may be deferred as a dependency, in favour of another output or control of a computing device, such as delivering the itinerary to another device. The reduced data file associated with Table 228-4 as compared to Table 228-3 is more technologically efficient in terms of memory storage and bandwidth, and thus a technological advantage in and of itself without generating the results on a display.

As another example, system 100 and method 300 can be modified for non-corporate leisure travel. In this example, the administrator parameters of block 304 may be provided by the users 124 themselves, so that their choices are pre-curated and/or normalized across different travel actors. Again, with the advent of large language models (LLMs), it is also contemplated that the parameters of block 304 can be provided in plain text form in lieu of a structured table such as Table 228-1. For example, the LLM prompt can state “For user 124-1, search for flights across different airlines, but only show the cheapest flights for each airline that have a baggage allowance of at least one bag”. Such a statement can be used to readily generate Table 228-1 using the LLM.

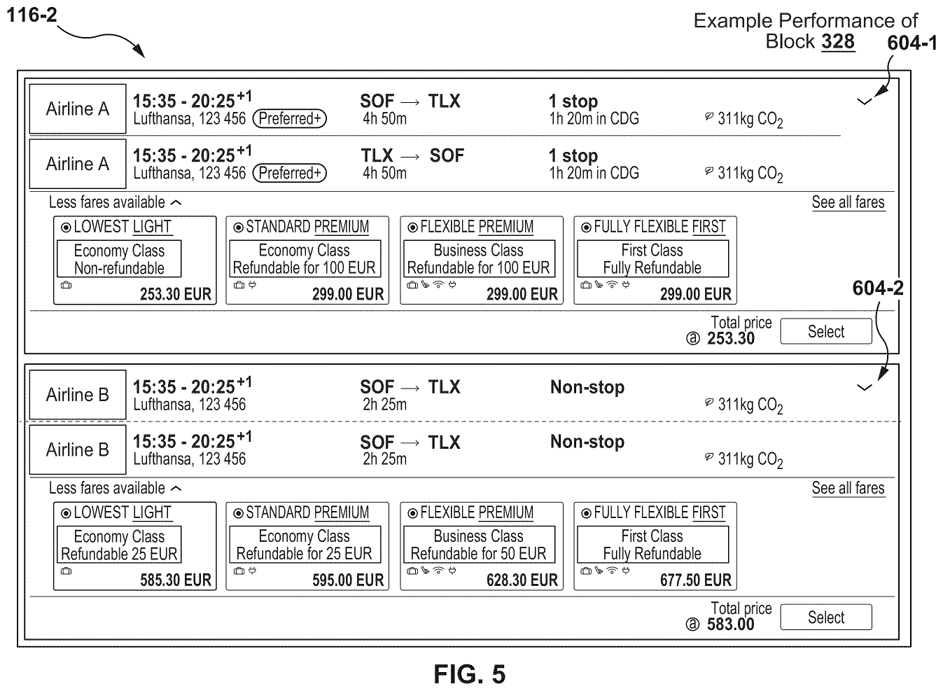

Referring now to FIG. 5, another example of how method 300 can be applied is shown on a sample display screen of a client device 116-2. According to the example in FIG. 5, the corresponding user 124-2 has a travel policy applied in a variant of Table 228-1 that shows four separate options across two different airlines. Each option represents a different set of tier of parameters. In this more complex example, the single set of options from FIG. 4 is expanded into four sets of tiers for each user 124. Those tiers are named “Lowest”; “Standard”; “Flexible” and “Fully Flexible”. Table 228-1b shows an example of the parameters for user 124-2.

TABLE 228-1b
Third Example Data Format of Administrator
Parameters (Example limited to user 124-2)

| | | | | Tier |
|---|---|---|---|---|
| | | | | Parameters |
| Identifier | Tier Parameters | Tier Parameters | Tier Parameters | (“Fully |
| object | (“Lowest”) | (“Standard”) | (“Flexible”) | Flexible”) |
| Identifier | Cheapest fare, | Semi-flexible | Semi-Flexible | Flexible |
| object 128-2 | 1 Checked-in | fare, Economy | Fare, Business | Fare, First |
| (User 124-2) | bag included | Class Seat | Class Seat, Wifi | Class Seat, |
| | | | | Wifi |

Thus, in FIG. 5, the four Tiers from Table 228-1b are shown for two different airlines. It is important to note that FIG. 5 represents a highly curated list, far reduced from the plethora of results that would have been generated in block 316. Furthermore, the results across Airline A and Airline B are normalized into single categories or tiers. Note, for example, that the “Lowest” Tier for Airline A generated an Economy Class seat that was non-refundable, while the “Lowest” Tier for Airline B generated an Economy Class seat that was refundable for a fee of 25 Euros. Both options for each Airline for the “Lowest” Tier are presented in the same vertical column of display 116-2, with the same Tier label “Lowest”, so that user 124-2 can readily compare what are the “Cheapest fares, with 1 Checked-in bag included” across Airline A and Airline B.

If we assume that at block 316, an additional option was generated for Airline B that was not refundable, but which did not include a checked-in bag; then this option has been removed because it does not satisfy the “Lowest” Tier parameters of Table 228-1b; this option omitting a checked-bag having been filtered out during normalization at block 324 by applying Table 228-1b to Table 228-2. The result is shown in FIG. 5, where the two “Lowest” tiers that satisfy the Tier Parameters for “Lowest” in Table 228b-1b are placed, elegantly, in vertical position to each other and thereby allow user 124-2 to make a rapid and informed comparison between the two Lowest Tier options from Airline A and Airline B. With minimal distraction, user 124-2 can note that the price of Airline A is lower, but has different flight times, allowing user 124-2 to focus simply on the price and flight time factors.

Such subtle complexity in the filtering of excess search results from block 316 by normalization at block 324 readily scales across the “Standard”, “Flexible” and “Fully Flexible” Tiers in FIG. 5. The result is an elegant curation to allow user 124-2 to readily compare a plurality of Tiers as shown in FIG. 5.

FIG. 5 shows another optional feature, whereby more than one flight for each Airline can be shown. While FIG. 5 shows specific examples of a single outbound and a corresponding return flight for each Airline, it is to be understood that a plurality of outbound and/or a plurality of return flights can be listed and the generation of the flight cards themselves allow for rapid comparison for elements such as between tiers, timing and prices of the Airlines due to the normalization of tiers as discussed herein.

Note that according to the example in FIG. 5, an expansion arrow 604 can be selected to expand and reveal the various Tier selections for a given flight. In FIG. 5, the tiers for Airline A—Flight 7824 have been expanded, and the tiers for Airline B—Flight 3413 have been expanded. Meanwhile, tiers for Airline A—Flight 3874 remain hidden (or collapsed) and tiers for Airline B—Flight 1345 remain hidden (or collapsed).

As shown in the example of FIG. 5 expansion arrow 604 has been selected for the TLX-SOF for Airline A and Airline B (Airline A—flight 7824 and Airline B—Flight 3413) and thus the two options can be compared in terms of both normalized tiers, pricing as well as flight times. Thus, collapse arrows 606 are offered to collapse display of tiers for Airline A—flight 7824 and Airline B—Flight 3413.

Note that interactions with display 116-2 can be configured so that selection of a tier in one expanded view will automatically result in selection of the same tier in another expanded view. This is demonstrated in FIG. 5 where the “Lowest” Tier is selected for both Airline A—flight 7824 and Airline B—Flight 3413

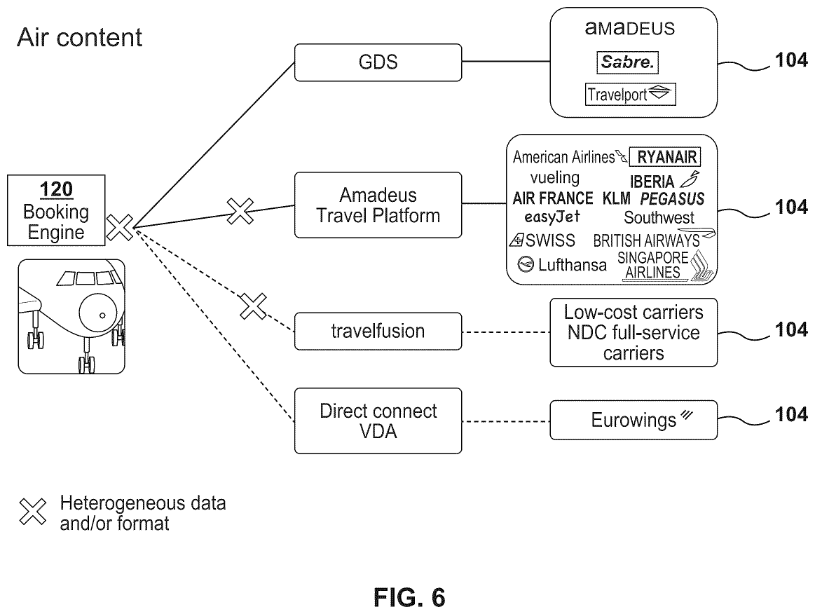

FIG. 6 shows a schematic representation of various presently commonly known air travel actor heterogenous formats that can be managed by booking engine 120 according to the teachings herein. The nodes on the right side of FIG. 6 show different possible types of travel actor engines 104, which themselves may be aggregates of other travel actor sources. (All trademarks belong to their respective owners). The booking engine itself has a first connection with one or more GDS such as Sabre or Amadeus, and a second connection with one or more care rental agencies. The data formats of these connections are heterogenous. The teachings herein regarding booking engine 120 can normalize such heterogeneousness.

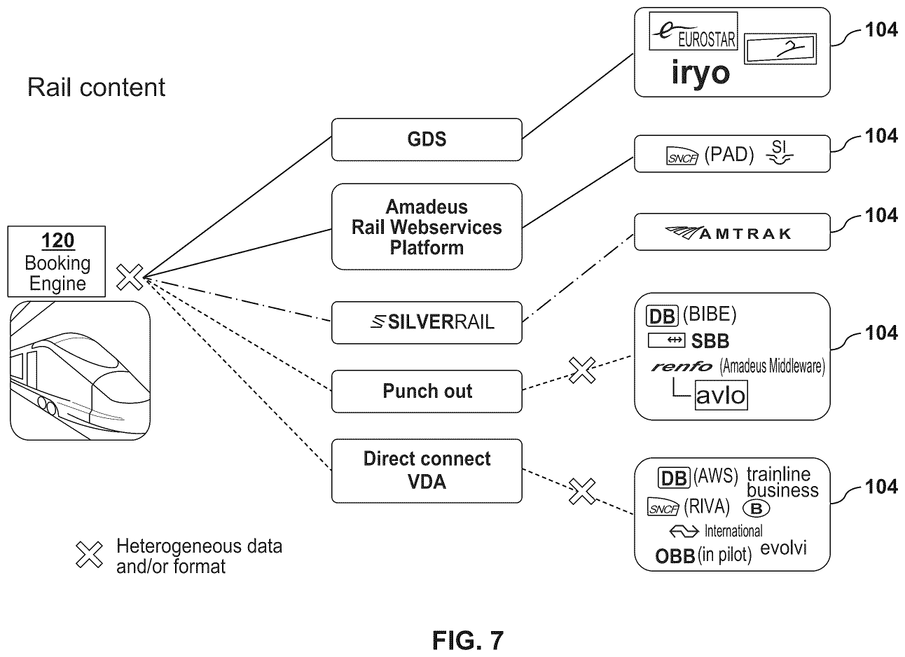

Likewise FIG. 7, which is of similar format to FIG. 6, shows a schematic representation of various presently commonly known rail travel actor heterogenous formats that can be managed by booking engine 120 according to the teachings herein. The nodes on the right side of FIG. 7 show different possible types of travel actor engines 104, which themselves may be aggregates of other travel actor sources. (All trademarks belong to their respective owners).

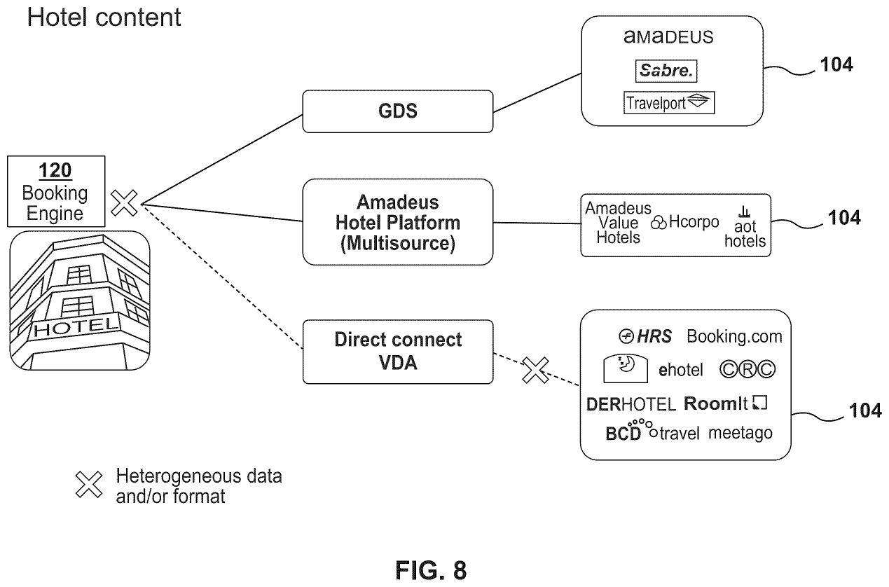

Likewise FIG. 8, also of similar format to FIG. 6, shows a schematic representation of various presently commonly known hotel travel actor heterogenous formats that can be managed by booking engine 120 according to the teachings herein. The nodes on the right side of FIG. 8 show different possible types of travel actor engines 104, which themselves may be aggregates of other travel actor sources. (All trademarks belong to their respective owners).

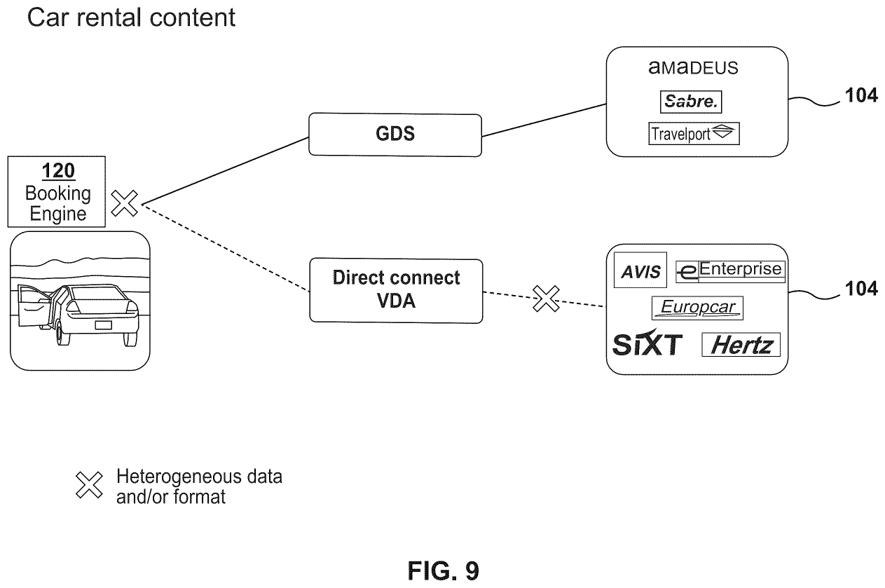

Likewise FIG. 9, also of similar format to FIG. 6, shows a schematic representation of various presently commonly known car rental travel actor heterogenous formats that can be managed by booking engine 120 according to the teachings herein. The nodes on the right side of FIG. 9 show different possible types of travel actor engines 104, which themselves may be aggregates of other travel actor sources. (All trademarks belong to their respective owners).

Furthermore, the teachings herein can be applied more broadly to any type of commercial offering made over an e-commerce system like system 100, and need not be limited to travel options, in which case booking engine 120 can be substituted for any suitable e-commerce platform. For example, an ecommerce site such as Amazon may have different vendors offering different shipping speeds, shipping guarantees, and associated pricing, and accordingly a user can select a vendor for a given product without having to conduct multiple searches or “add to cart” functions to in order to compare pricing and shipping options.

Furthermore, other graphical representations other than a grid as shown in FIG. 4 or FIG. 5 may be shown, such as a list.

Furthermore, the parameters in Table 228-1 are not particularly limited. For example, preferred airlines may also be specified.

A person skilled in the art will now appreciate that the teachings herein can improve the technological efficiency and computational and communication resource utilization across system 100 by normalizing data and controlling a display device in a fashion that mitigates the need to run multiple searches, thereby reducing the overall burden on traffic resources of network 308 and computational resources on devices 116 and engines 104. It is the heterogeneousness referenced at block 316 that can lead to users 124 having to conduct repeated and seeming endless searches so they can compare all of the options, thereby wasting Internet bandwidth as well as local and remote processing and memory resources, one of the technical advantages of the present specification, in addition to others discussed throughout. Other technical advantages will occur to those of skill in the art.

It should be recognized that features and aspects of the various examples provided above can be combined into further examples that also fall within the scope of the present disclosure. In addition, the figures are not to scale and may have size and shape exaggerated for illustrative purposes.

1. A computing resource optimization engine comprising a processor and a memory for storing instructions executable on the processor; the processor configured to:
receive a data format of administrator travel itinerary parameters;
receive an electronic request for a proposed travel itinerary;
query a plurality of travel actor servers for the travel itinerary based on the request;
receive a plurality of heterogeneous travel itinerary response messages from the travel actor servers; the messages including heterogeneous offer attributes data fields from different travel actor servers;
parse each response message into a plurality of attributes;
determine a normalized set of travel itineraries by mapping the heterogenous offer attributes data fields into corresponding parameters defined by the data format;
control a display device to generate the normalized set of travel itineraries according to the parameters.

2. The computing resource optimization engine of claim 1 wherein the messages include heterogeneous fare class data fields including non-refundable fare, refundable fare with fee and fully refundable fare from a first travel actor server and including non-refundable fare and refundable fare with fee from a second travel actor server, and wherein the refundable fare with fee and fully refundable fare are merged into a single flexible fare parameter.

3. The computing resource optimization engine of claim 1 wherein the processor is further configured to discard at least one attribute that falls outside the parameters.

4. The computing resource optimization engine of claim 1 wherein the display device is interactive and can receive a selection of one of the itineraries.

5. The computing resource optimization engine of claim 4 wherein the display device can receive a selection of one of the parameters within the one of the itineraries.

6. The computing resource optimization engine of claim 5 wherein at least a portion of the parameters can be revealed or hidden on the display device for each of the itineraries.

7. The computing resource optimization engine of claim 6 wherein fare class data fields are within the portion of the parameters.

8. The computing resource optimization engine of claim 1 wherein the travel actor servers include one or more of a global distribution server and a new distribution capability (NDC) protocol-based server.

9. The computing resource optimization engine of claim 1 wherein the query is effected via an application programming interface (API) executing on the processor or travel actor servers.

10. The computing resource optimization engine of claim 1 wherein the travel actor servers can include air travel actor servers and rail travel actor servers.

11. A computing resource optimization method comprising:
receiving a data format of administrator travel itinerary parameters;
receiving an electronic request for a proposed travel itinerary;
querying a plurality of travel actor servers for the travel itinerary based on the request;
receiving a plurality of heterogeneous travel itinerary response messages from the travel actor servers; the messages including heterogeneous offer attributes data fields from different travel actor servers;
parsing each response message into a plurality of attributes;
determining a normalized set of travel itineraries by mapping the heterogenous offer attributes data fields into corresponding parameters defined by the data format;
controlling a display device to generate the normalized set of travel itineraries according to the parameters.

12. The method of claim 11 wherein the messages include heterogeneous fare class data fields including non-refundable fare, refundable fare with fee and fully refundable fare from a first travel actor server and including non-refundable fare and refundable fare with fee from a second travel actor server, and wherein the refundable fare with fee and fully refundable fare are merged into a single flexible fare parameter.

13. The method of claim 11 further comprising discarding at least one attribute that falls outside the parameters.

14. The method of claim 11 wherein the display device is interactive and can receive a selection of one of the itineraries.

15. The method of claim 14 wherein the display device can receive a selection of one of the parameters within the one of the itineraries.

16. The method of claim 15 wherein at least a portion of the parameters can be revealed or hidden on the display device for each of the itineraries.

17. The method of claim 16 wherein fare class data fields are within the portion of the parameters.

18. The method of claim 11 wherein the travel actor servers include one or more of a global distribution server and a new distribution capability (NDC) protocol-based server.

19. The method of claim 11 wherein the query is effected via an application programming interface (API) executing on a processor or at least one of the travel actor servers.

20. The method of claim 11 wherein the travel actor servers can include air travel actor servers and rail travel actor servers.
